(19) United States
(12) Patent Application Publication
(10) Pub. No.: US 2008/0016761 A1
(43) Pub. Date: Jan. 24, 2008

(54) Wire foliage container with rigid support

(76) Inventor: Bradley Emalfarb, Riverwoods, IL (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/490,404

(22) Filed: Jul. 20, 2006

(51) Int. Cl. A01G 9/02

(52) U.S. Cl. 47/39; 47/66.6

(57) ABSTRACT

The combination of a support and a foliage container. The foliage container has a plurality of elongate elements that cooperatively produce at least a part of a wall structure bounding a receptacle within which foliage can be placed, and a base rigidly secured to the wall structure. The base is configured to be rigidly connected to the support so that the support consistently maintains the wall structure in an operative orientation.

### BACKGROUND OF THE INVENTION

1. Field of the Invention

This invention relates to containers for foliage having a receptacle bounded at least in part by wire elements and, more particularly, to containers of this type which can be rigidly connected to a support therefor.

2. Background Art

Containers for foliage, such as plants and flowers, come in a wide range of designs. With the proliferation of decks on homes, there has been a trend towards designing foliage containers that can be displayed seasonally in an attractive manner on these decks. One of the most popular styles of container is that having a receptacle bounded by formed wire. Within the receptacle, either self-contained planters or porous material, such as shredded coconut husk, can be inserted, with the latter offering an alternative to fixed configuration containers.

The wire containers are desirable for a number of reasons. First, the wire containers lend themselves to relatively inexpensive construction. Receptacles of different size and shape can be offered without the high expenses normally associated with customization.

The wire containers are generally light in weight. Thus, they can be shipped relatively inexpensively and handled conveniently by the manufacturers, transporters and end users.

Wire containers lend themselves to nested stacking in a compact manner. This feature also contributes to controlled shipping costs. Additionally, many sizes and shapes of the containers can be displayed in a relatively compact space, thereby potentially maintaining relatively low shelving costs.

Wire containers are commonly made with either fixed dimension, or adjustable, hangers through which they can be conveniently hung from deck rails, on mail boxes, etc. By simply vertically translating the hanging portions of the containers over a rail, the containers can be placed and maintained in an operative state. Users are afforded the convenience of being able to conveniently relocate the containers without performing any complicated steps of removing and re-installing separate fasteners, thereby also avoiding unwanted, and potentially unsightly, modification to the supporting structure for the containers.

The wire containers are also desirable for their aesthetics. The wires alone accent, but do not dominate, the appearance of that placed in the container receptacle. The wires also lend themselves to adornment, to further enhance their visual appeal.

Heretofore, wire containers have been limited generally to loose, hanging installation. While this construction offers great versatility in terms of being able to selectively place and reposition the container in various locations around a deck rail, or the like, this construction has generally been limited to being located wherever inverted, U-shaped hangers can be installed. Generally, this requires a supporting surface that is elongate in a horizontal direction.

The industry continues to seek out designs of these wire containers that afford even additional versatility in terms of where and how they might be mounted so as to increase customer interest in this type of product.

### SUMMARY OF THE INVENTION

In one form, the invention is directed to the combination of a support and a foliage container. The foliage container has a plurality of elongate elements, that cooperatively produce at least a part of a wall structure bounding a receptacle within which foliage can be placed, and a base rigidly secured to the wall structure. The base is configured to be rigidly connected to the support so that the support consistently maintains the wall structure in an operative orientation.

In one form, the support is a vertically extending support.

The structure may further be provided in combination with a foliage insert that at least nominally conforms to and resides within the receptacle.

In one form, the vertically extending support is in the form an upright post to which a horizontally extending rail connects.

In one form, the upright post has a top end and the base has a mounting receptacle for the top end of the upright post.

In one form, the upright post has a polygonal peripheral shape defined by a plurality of transverse surfaces, as viewed in horizontal cross section. The base has at least two surfaces that conform to first and second of the transverse surfaces.

In one form, the base has a wall that nominally conforms to and surrounds the polygonal peripheral shape with the base rigidly connected to the vertically extending support.

In one form, the at least one of the base and wall structure has a horizontal wall that is exposed through the receptacle within which foliage can be placed. A fastener, accessible through the receptacle, extends through the horizontal wall into the upright post to fixedly maintain the base rigidly connected to the upright post.

In one form, the vertically extending post is in the form of a stake that is directed into a support surface.

The base may be made from a plurality of joined, elongate elements.

In one form, the base is in the form of a flat, horizontally extending plate.

In one form, the support is in the form of rail with a peripheral shape including two transverse, vertically extending surfaces. The base has first and second surfaces that conform, one each, to the two transverse surfaces.

In one form, the support has discrete, substantially flat, vertically extending first and second surfaces and the base has two surfaces that conform, one each, to the first and second surfaces and are each adjacent to, or against, one of the first and second surfaces.

In one form, the first and second surfaces are substantially flat and reside in first and second planes that are parallel to, and spaced from, each other.

In another form, the planes are non-parallel to each other.

In one form, the relationship between the two surfaces on the base is selectively adjustable.

In one form, at least one of the two surfaces can be moved selectively towards and away from the other of the two surfaces to vary spacing between the two surfaces to captively engage surfaces on the support of different widths.

In one form, the vertically extending support is in the form of an upright post to which a mail box is attached.

In one form, the vertically extending support has a top free end with a peripheral surface and the base has a first wall structure that defines a first mounting receptacle into which the top free end is extended and which nominally conforms to the peripheral surface. The base further has a second wall structure that defines a second mounting receptacle into which the top free end of a vertically extending support having at least one of: a) a different dimension; and b) a different shape than is accommodated by the first mounting receptacle can be extended. At least part of the first wall structure is separable from the remainder of the base to allow the second wall structure to be used.

In one form, the plurality of elongate elements is at least one of wires and straps.

### BRIEF DESCRIPTION OF THE DRAWINGS

FIG. 1 is schematic representation of a system, according to the present invention, including a foliage container having a wall structure and a base through which the foliage container is connected to a support;

FIG. 2 is a schematic representation of the foliage container in FIG. 1 with a foliage insert placed in a receptacle defined by the wall structure;

FIG. 3 is a bottom perspective view of one form of foliage container as shown in FIG. 1;

FIG. 4 is a top perspective view of the foliage container in FIG. 3 in relationship to a support therefor, in the form of an upright post;

FIG. 5 is a reduced, side elevation view of the foliage container of FIGS. 3 and 4 operatively connected to an upright support upon which a mail box is mounted;

FIG. 6 is a view as in FIG. 5 wherein the upright support is part of a fence system;

FIG. 7 is a view as in FIG. 6 wherein the upright support 12 is part of a wall, as on a deck, or the like;

FIG. 8 is a perspective view of a modified form of foliage container on an upright support wall, as in FIG. 7;

FIG. 9 is a view as in FIG. 8 showing a modified form of wall structure on the foliage container;

FIG. 10 is a perspective view of a further modified form of foliage container connected to a support in the form of an elongate, vertically extending stake that can be supported, as through a subjacent surface;

FIG. 11 is a view as FIG. 10 of a modified form of foliage container with a support stake of the type shown in FIG. 10.

FIG. 12 is a fragmentary, perspective view of an upright support at the juncture between horizontally extending elements to which another form of foliage container, according to the present invention, is connected;

FIG. 13 is a bottom, perspective view of the foliage container in FIG. 12;

FIG. 14 is a bottom view of a modified form of base including two walls for straddling a support;

FIG. 15 is a view as in FIG. 14 of a modified form of base with a single wall on the base;

FIG. 16 is a side elevation view of a further modified form of base with adjustable straps to straddle a support;

FIG. 17 is a view as in FIG. 16 of a base with a modified form of strap;

FIG. 18 is a view as in FIGS. 15 and 16 wherein a dimension of a mounting receptacle defined by a base shown therein is variable; and

FIG. 19 is a bottom view of the foliage container in FIGS. 3 and 4, modified to include a separate wall structure that is removable to provide two different configurations of base to cooperate with different supports.

### DETAILED DESCRIPTION OF THE DRAWINGS

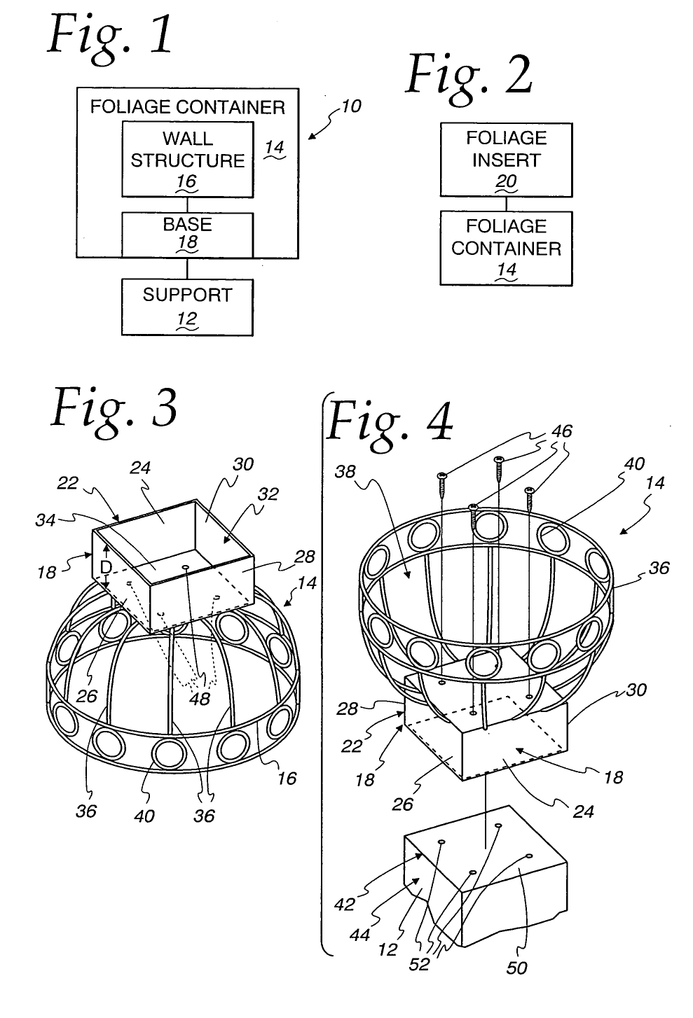

In FIG. 1, a system, according to the invention, is shown schematically at 10 that is a combination of a support 12 and foliage container 14. The foliage container 14 has a plurality of elongate elements that cooperatively produce a wall structure 16 bounding at least a part of a receptacle within which foliage can be placed. A base 18 is rigidly secured to the wall structure 16. The base 18 is configured to be rigidly connected to the support 12 so that the support 12 in turn can be used to rigidly maintain the wall structure 16 in an operative orientation. The support 12 and foliage container 14 are shown schematically in that they may take virtually a limitless number of different shapes, with exemplary forms as described below. What is consistent in the design is that the wall structure 16 is made from elongate elements that produce a skeletal-type wall structure 16 that bounds a foliage receptacle. The elongate elements may be straight, bent, circular, etc. to define a “see through” wall structure 16. They may be made from any rigid material, such as metal, plastic, rubber, a composite, etc.

As shown in FIG. 2, the receptacle defined by the wall structure 16 on the foliage container 14 is designed to accommodate a foliage insert 20. The foliage insert 20 may be another container, such as a conventional flower pot, a formed component made of compacted, porous material, such as shredded coconut, etc. Again, the foliage insert 20 is shown schematically in FIG. 2 to encompass virtually a limitless number of types of insert and shapes therefor that can be placed in the receptacle of the foliage container 14.

One specific form of the foliage container 14 is shown in FIGS. 3 and 4. In this embodiment, the base 18 consists of a wall structure 22 made up of four flat, rectangular, flat, walls 24, 26, 28, 30 arranged to cooperatively produce a square mounting receptacle 32 with a depth D. The mounting receptacle 32 is bounded by a horizontally extending, flat wall 34 that may be viewed as part of the base 18 and/or wall structure 16. The wall structure 22 of the base 18 is joined in relationship to the horizontal wall 34 so that the mounting receptacle 32 has an inverted cup shape.

In this embodiment, the wall structure 16 on the foliage container 14 is defined by elongate elements that are in the form of wires 36 that are welded or otherwise joined together to produce a desired shape that, in this case, bounds a cup-shaped receptacle 38 for the foliage insert 20, which receptacle 38 opens oppositely to the direction of opening of the mounting receptacle 32. The number, length, shape, arrangement, etc. of the wires 36 is not critical to the present invention. As also noted above, it is desirable that the wall structure 22 essentially be “skeletal” in nature to support the foliage insert 20 that can be observed therethrough. As still further noted previously, the designation “elongate elements” is intended to include the ring-shaped components 40 shown that, can each be considered to be a formed elongate element.

The base 18, which will be considered for purposes herein to include the horizontal wall 34, is configured to cooperate with the vertically extending support 12, shown in the form of an upright post with a top free end 42. The top end 42 of the upright post 12 has a peripheral shape/surface 44 that in this case is shown to be polygonal, and more particularly square, in shape. It is preferred that the peripheral shape/surface 44 conform at least nominally, and more preferably closely, to the shape around the mounting receptacle 32 bounded by the wall structure 22. With this conforming relationship, the base 18 can be frictionally connected to and rigidly maintained upon the upright post 12.

Alternatively, if there is but a nominal correspondence in shape, a rigid, fixed connection can be maintained by directing fasteners 46 through the receptacle 38 and into and through pre-formed openings 48 in the horizontal wall 34 and into a top surface 50 on the upright post 12, as indicated by the hole locations at 52.

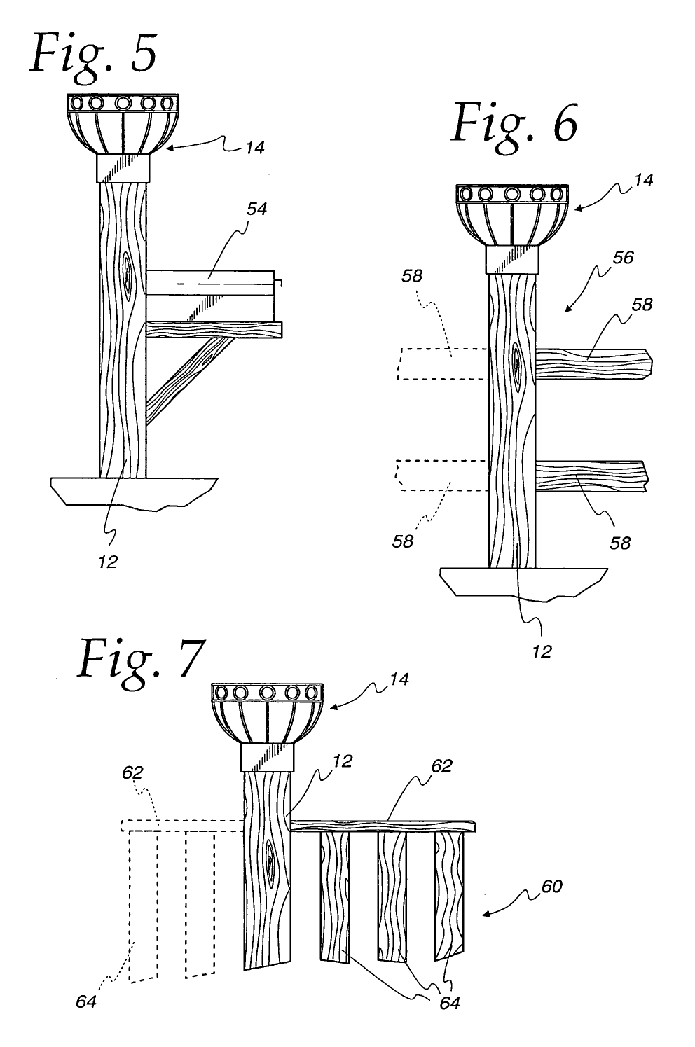

The wall structure 16 and base 18 on the foliage container 14 can be made from any suitable material, such as plastic, metal, or a composite. It is preferred that the base 18 be made from a material having a gauge sufficient to rigidly support the wall structure 16 in an operative orientation with respect to the upright post 12. The invention contemplates use of the above-described foliage container configuration in many diverse areas. As one example, as shown in FIG. 5, the upright post 12 may be used to support a mail box 54. The foliage container 14 provides a decorative addition thereto.

In FIG. 6, the upright post 12, to which the foliage container 14 is connected, is shown as part of a fence system at 56. The upright post 12 serves to support horizontal slats 58. The upright post 12 may be at a corner, with the slats 58 as shown in solid lines, or at a transition between sections of slats 58, as indicated by the slats 58 shown in dotted lines in FIG. 6.

In FIG. 7, the upright post 12 with the foliage container 14 thereon is shown integrated into a wall 60 associated with a deck, or the like. The wall 60 has a top rail 62 connected to vertical slats 64. The upright post 12 maybe provided at a corner, as shown in solid lines, or at a juncture between adjacent rail sections, which is indicated by the dotted lines showing of the additional top rail 62 and slats 64 in FIG. 7.

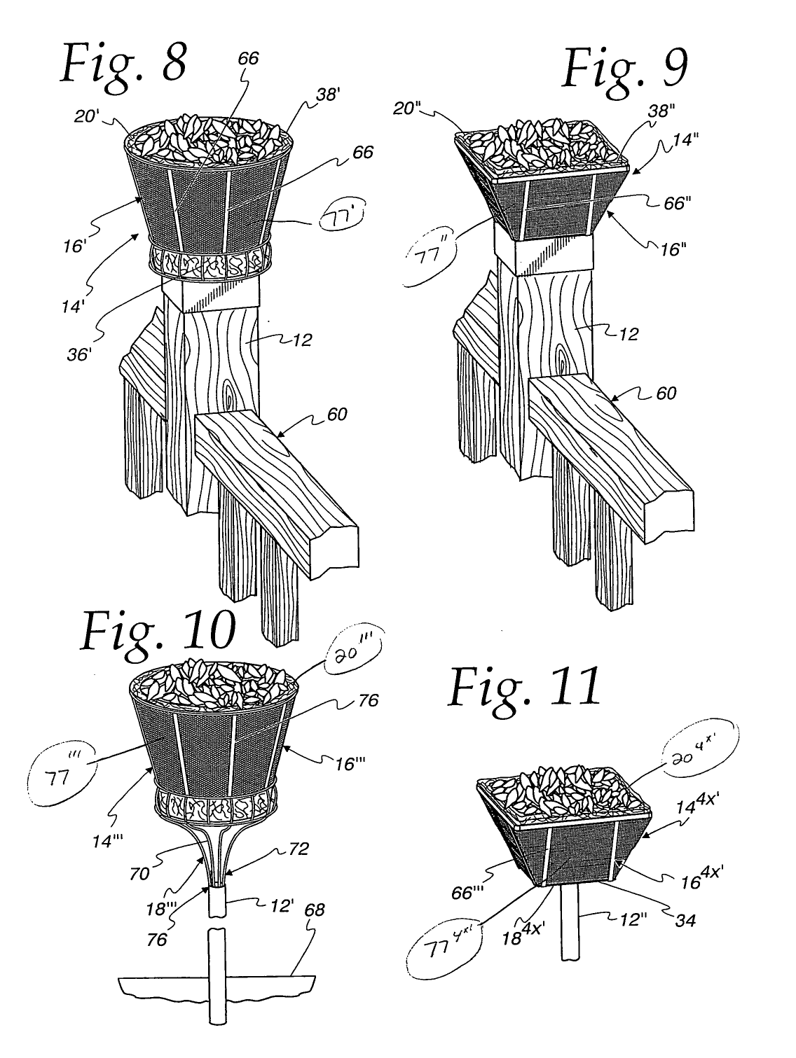

Different variations of the foliage container 14 are shown at 14′ and 14″ in FIGS. 8 and 9, respectively, on an upright post 12 that is part of a wall 60. The wall structure 16′ on the foliage container 14′ is made from a combination of round wires 36′ and flat wires in the form of straps 66 joined to produce a receptacle 38′ for the foliage insert 20′.

In FIG. 9, substantially the entire wall structure 16″ is made from straps 66″ to produce a receptacle 38″ for a foliage insert 20″.

In FIG. 10, a modified form of foliage container for a liner 20′″ is shown at 14′″ in association with a support 12′ that is in the form of an elongate stake that is directed through, and thereby supported with respect to, a subjacent surface 68. The stake 12′ may be driven into the ground or otherwise anchored, either permanently or temporarily.

In this embodiment, the base 18′″ is in the form of a plurality of formed wires 70 that connect between the wall structure 16′″ and the stake 12′. The lower ends 72 of the base wires 70 are directed into the top end 76 of the stake 12′ and suitably, fixedly secured thereto. The wires 70 may be joined to wires 76 on the wall structure 16′″, or may be contiguous therewith so that there is no clear division between the base 18′″ and wall structure 16′″.

A further modified form of foliage container is shown at 14^{4X′} in FIG. 11. In this embodiment, straps 66′″ are used to define the wall structure 16^{4X′} that accepts a liner 20^{4X′}. The straps 66′″ are joined to the base 18^{4X′} that is in the form of the aforementioned horizontal plate 34. An upright post/stake 12″ is connected to the base 18^{4X′} and can be suitably secured, as for the stake 12′ in FIG. 10.

In the embodiments shown in FIGS. 8-11, the liners 20′, 20″, 20′″, 20^{4X′} are each surrounded by a sheet layer 77′, 77″, 77′″, 77^{4X′} that confines any loose material making up the liners 20′, 20″, 20′″, 20^{4X′}.

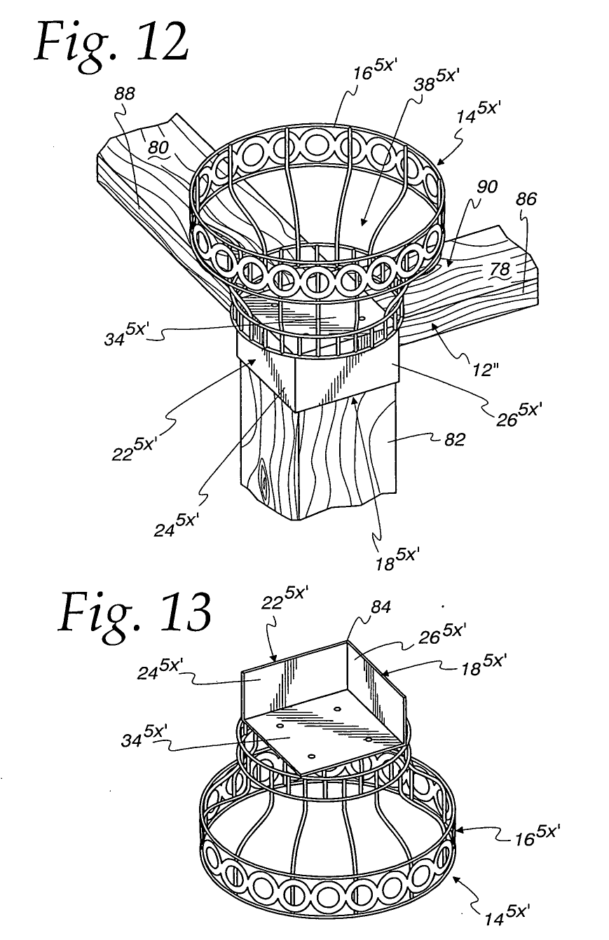

In FIGS. 12 and 13, a modified form of foliage container is shown at 14^{5X′} for use on a modified form of support 12″. The foliage receptacle 14^{5X′} is shown connected to the support 12″ at a corner location, as where horizontally extending elements 78, 80 meet at an upright corner support post 82.

In this embodiment, the base 18^{5X′} consists of a horizontal wall 34^{5X′} secured at the bottom of a wall structure 16^{5X′} defining a foliage receptacle 38^{5X′}. A wall structure 22^{5X′}, corresponding to the wall structure 22 shown in FIGS. 3 and 4, is made with but two walls 24^{5X′}, 26^{5X′} that meet at a corner 84.

With this arrangement, transverse, vertically extending, peripheral surfaces 86, 88 on the elements 78, 80, respectively, nest against the walls 26^{5X′}, 22^{5X′}, respectively at the corner 84. The horizontal wall 34^{5X′} bears upon an upwardly facing surface 90 defined by one or both of the elements 78, 80. Suitable fasteners (not shown) can be directed through the horizontal wall 34^{5X′} and/or wall structure 22^{5X′}, as desired, into one or any/all of the elements 78, 80 and corner support 82.

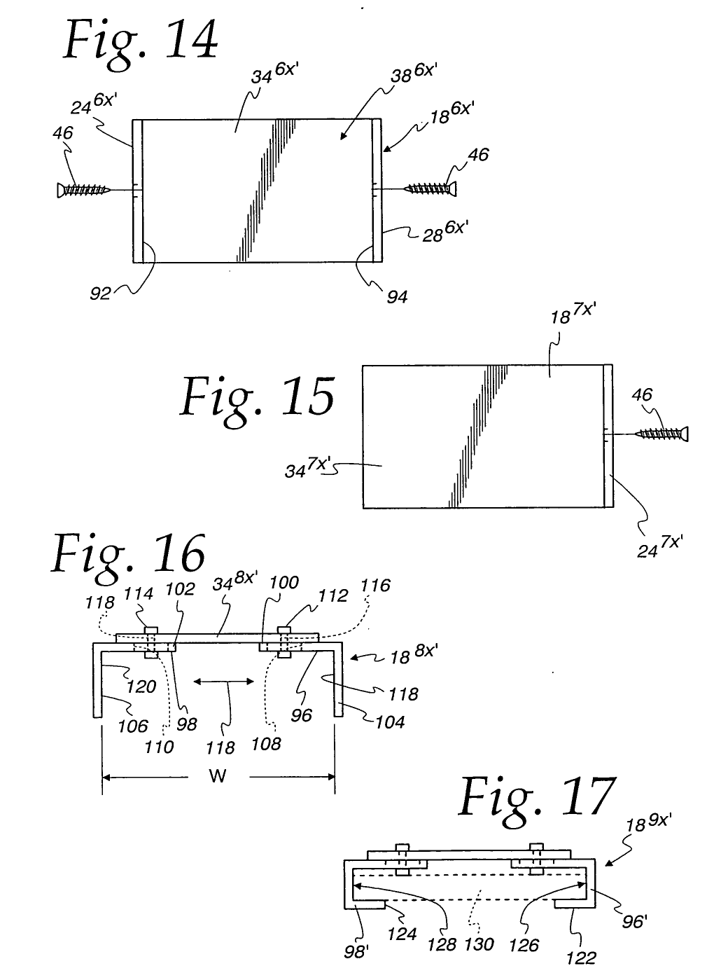

In FIG. 14, a modified form of the base is shown at 18^{6X′} with a horizontal wall 34^{6X′} having depending walls 24^{6X′}, 28^{6X′} with surfaces 92, 94, respectively, bounding a mounting receptacle 38^{6X′}. The planes of the surfaces 92, 94 are substantially parallel to straddle an element (not shown) that functions as a support therefor. Fasteners 46 can be directed through one or both of the walls 24^{6X′}, 28^{6X′} and/or through the horizontal wall 34^{6X′} to maintain the base 18^{6X′} rigidly connected to an associated support.

In FIG. 15, a further modified form of the base is shown at 18^{7X′} with a horizontal wall 34^{7X′} and depending wall 24^{7X′} that can be attached to an appropriate support using fasteners 46 extending through the wall 24^{7X′} and/or the horizontal wall 34^{7X′}.

As noted above, the base can be made with but a single, vertically extending wall having a surface that bears against a support surface. Alternatively, as in FIG. 14, a pair of vertically extending walls can be provided, each with flat surfaces that are substantially parallel to straddle a support.

In FIGS. 12 and 13, the pair of vertically extending walls have transverse surfaces to engage a support. In FIGS. 3 and 4, the wall structure fully surrounds an appropriate support. The invention contemplates that many other combinations of walls and surfaces thereon for a base might be devised by one skilled in the art, with the inventive principles in hand.

The invention also contemplates that the capacity of the base can be adjustable. In FIG. 16, a base is shown at 18^{8X′} with a horizontal wall 34^{8X′} having associated straps 96, 98. Each of the straps 96, 98 is L-shaped with horizontal legs 100, 102 and vertical legs 104, 106, respectively. The horizontal legs 100, 102 have elongate slots 108, 110 for fasteners 112, 114 directed through openings 116, 118 in the horizontal plate 34^{8X′}. The slots 108 and 110 allow the straps 96, 98 to be moved selectively towards and away from each other along the line of the double headed arrow 118, to thereby selectively vary the straddling width W between facing surface 118, 120 on the legs 104, 106. By loosening the fasteners 112, 114, an appropriate adjustment can be made, whereupon the fasteners 112, 114 can be re-tightened to maintain the desired relationship between the straps 96, 98. Connection of the base 18^{8X′} to a suitable support can be accomplished as described above.

In FIG. 17, a variation of the base of FIG. 16 is shown at 18^{9X′}. The base 18^{9X′} has straps 96′, 98′ functioning as the straps 96, 98 in FIG. 16, with the exception that the straps 96′, 98′ have a return bend 122, 124, respectively, to define U-shaped receptacles 126, 128 opening towards each other and designed to straddle the ends of the rectangular cross section of a support 130.

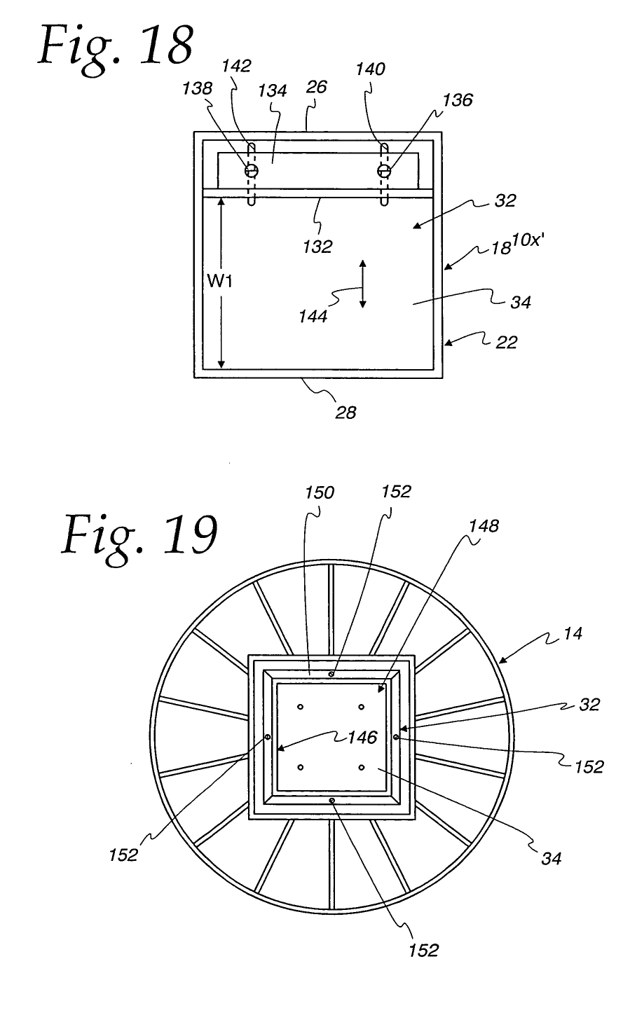

In FIG. 18, a further modified form the base is shown at 18^{10X′} and consists of the aforementioned wall structure 22 and the horizontal wall 34. A wall 132 is provided within the mounting receptacle 32 and moveable guidingly between the walls 26, 28 to variably select a width dimension W1 between the walls 28, 132 for the mounting receptacle 32. The wall 132 has a transverse flange 134 through which fasteners 136, 138 extend. Elongate slots 140, 142 in the horizontal wall 34 allow fasteners 136, 138 directed therethrough to slide guidingly as the wall 132 moves in the direction of the double headed arrow 144. The fasteners 136, 138 can be tightened to maintain a desired width dimension W1. The base 18^{10X′} can be attached to an appropriate support, as described above. The wall 132 may be separated by releasing the fasteners 136, 138.

In FIG. 19, a further modification to the foliage container 14 is shown. A squared wall structure 146 is mounted removably within the mounting receptacle 32 and has a smaller size mounting receptacle 148. The wall structure 146 has a peripheral, outturned flange 150 through which the wall structure 146 is releasably secured to the horizontal wall 34 through fasteners 152.

With this structure, the user has the option of using the wall structure 146 having the smaller dimension mounting receptacle 148. Alternatively, the fasteners 150 can be removed to separate the wall structure 146, whereupon the wall structure 22 can be utilized as previously described.

As an alternative to having the wall structures 22, 146 merely scaled in size, they may define different shapes for the mounting receptacle 32, 148 to accommodate different supports.

The foregoing disclosure of specific embodiments is intended to be illustrative of the broad concepts comprehended by the invention.

1. In combination:
a) a support; and
b) a foliage container, the foliage container comprising:
a plurality of elongate elements that cooperatively produce at least apart of a wall structure bounding a receptacle within which foliage can be placed; and
a base rigidly secured to the wall structure,
the base configured to be rigidly connected to the support so that the support consistently maintains the wall structure in an operative orientation,
the base and support having complementary surfaces that interact to key the base and support against relative movement with the wall structure in the operative orientation.

2. The combination according to claim 1 wherein the support is a vertically extending support.

3. The combination according to claim 2 in combination with a foliage insert that at least nominally conforms to and resides within the receptacle.

4. The combination according to claim 2 wherein the vertically extending support comprises an upright post to which a horizontally extending rail connects.

5. The combination according to claim 4 wherein the upright post has a top end and the base has a mounting receptacle for the top end of the upright post.

6. The combination according to claim 5 wherein the upright post has a polygonal peripheral shape defined by a plurality of transverse surfaces as viewed in horizontal cross section and the base has at least two surfaces that conform to first and second of the transverse surfaces.

7. The combination according to claim 5 wherein the top end of the upright post has a polygonal peripheral shape defined by a plurality of transverse surfaces as viewed in horizontal cross section and the base has a wall that nominally conforms to and surrounds the polygonal peripheral shape with the base rigidly connected to the vertically extending support.

8. The combination according to claim 5 wherein at least one of the base and wall structure has a horizontal wall that is exposed through the receptacle within which foliage can be placed and a fastener, accessible through the receptacle within which foliage can be placed, extends through the horizontal wall and into the upright post to fixedly maintain the base rigidly connected to the upright post.

9. The combination according to claim 2 wherein the vertically extending post is in the form of a stake that is directed into a support surface.

10. The combination according to claim 2 wherein the base comprises a plurality of joined elongate elements.

11. The combination according to claim 2 wherein the base comprises a flat, horizontally extending plate.

12. The combination according to claim 1 wherein the support comprises a rail with a peripheral shape comprising two transverse, vertically extending surfaces and the base has first and second surfaces that conform, one each, to the two transverse surfaces.

13. The combination according to claim 1 wherein the support comprises discrete, substantially flat, vertically extending first and second surfaces and the base has two surfaces that conform, one each, to the first and second surfaces and are each adjacent to, or against, one of the first and second surfaces.

14. The combination according to claim 13 wherein the first and second surfaces are substantially flat and reside in first and second planes that are parallel to, and spaced from, each other.

15. The combination according to claim 13 wherein the first and second surfaces are substantially flat and reside in first and second planes that are non-parallel to each other.

16. The combination according to claim 13 wherein a relationship between the two surfaces on the base is selectively adjustable.

17. The combination according to claim 16 wherein the two surfaces on the base are substantially flat and reside in planes that are substantially parallel to each other and at least one of the two surfaces can be moved selectively towards and away from the other of the two surfaces to vary spacing between the two surfaces to captively engage surfaces on the support of different widths.

18. The combination according to claim 2 wherein the vertically extending support comprises an upright post to which a mail box is attached.

19. The combination according to claim 2 wherein the vertically extending support has a top free end with a peripheral surface, the base has a first wall structure that defines a first mounting receptacle into which the top free end is extended and which nominally conforms to the peripheral surface and a second wall structure that defines a second mounting receptacle into which the top free end of a vertically extending support having at least one of: a) a different dimension; and b) a different shape than is accommodated by the first mounting receptacle can be extended, at least part of the first wall structure separable from a remainder of the base to allow the second wall structure to be used.

20. The combination according to claim 1 wherein the plurality of elongate elements comprises at least one of wires and straps.
